(19) United States
(12) Patent Application Publication
(10) Pub. No.: US 2011/0044064 A1
(43) Pub. Date: Feb. 24, 2011

(54) FLASH LIGHT FOR A BICYCLE WITH THE FUNCTION OF DIRECTION AND ELEVATION INDICATION

(76) Inventors: Chi-Hsien Hu, Taipei Hsien (TW); Jen-Chao Hu, Taichung City (TW); Chang-Hua Yuan, Taichung City (TW)

Correspondence Address: CHI-HSIEN HU, 235 Chung - Ho Box 8-24, Taipei, TW

(21) Appl. No.: 12/542,723

(22) Filed: Aug. 18, 2009

(51) Int. Cl. B62J 6/00

(52) U.S. Cl. 362/473; 362/157

(57) ABSTRACT

A flash light for a bicycle with the function of direction and elevation indication comprises: a casing; a ball shape compass for indication of direction; an upper side of the compass exposing out of the casing; a circuit board installed within the casing; the circuit board including a pressure sensing IC and a processor; the pressure sensing IC serving for sensing the atmosphere and converting the atmosphere into elevation; the processor being connected to the pressure sensing IC for receiving the signals from the pressure sensing IC; a display for displaying values about the elevation; a touch switch in contact with a lower side of the compass; when the compass is pressed, it will press the touch switch to actuate a power of the circuit board and thus the elements on the circuit board being actuated; and an LED lamp set installed on the lamp seat.

### FIELD OF THE INVENTION

The present invention relates to bicycle lights, and particularly to a flash light for a bicycle with the function of direction and elevation indication, which has light sources of LEDs.

### BACKGROUND OF THE INVENTION

Currently, bicycles have become a popular traffic tool and exercise tool. More and more people drive bicycle for exercising and traffic reasons. To be safe at night, the bicycles are added with lights. Currently, the lights of bicycle have a form of flashlight which can be taken down. For example, in the prior art U.S. Pat. No. 6,837,599 discloses a warning light of bicycle which comprises a flashlight comprising a battery compartment including spaced, arcuate projections around a forward extension, a rear holed tab for connection to a lanyard, and a bottom slot; a cylindrical LED carrier assembly including rear contacts electrically interconnecting cells and LEDs; and a cylindrical head assembly including inner recesses engaged with $ projections by turning the head assembly a small angle about the battery compartment; and a clip assembly releasably secured around a tube component of the bicycle, an upper seat having two arcuate wings for clamping the battery compartment, a latch member inserted into the slot for fastening the flashlight, and a flexible tab adapted to press down to clear the latch member from the slot for disengaging the flashlight from the clip assembly.

Furthermore, currently, LEDs are widely used as light sources, one usage is to use LED as flashlight, for example in U.S. Pat. No. 7,387,402 discloses a multiple light LED flashlight comprising an elongate tubular housing and a bulb housing, a quick disconnect mechanism positioned between the tubular housing and the bulb housing, the tubular housing defining a chamber sized and configured to receive at least one battery, the quick disconnect mechanism adapted to provide access to the chamber by removal of the bulb housing from an end of the tubular housing, the bulb housing comprises an outer shell member and a lower shell member that are secured together, a housing is positioned within a region defined between the outer shell member and the lower shell member, a lens assembly is positioned generally between the housing and the outer shell member, the lens assembly comprising a plurality of lenses that are integrally formed and a plurality of LED's extending through a portion of the housing and being generally aligned with a respective lens of the lens assembly.

Conventionally, the flashlights only have the function of illumination with the power source of tungsten silks, while LED light sources are more and more popular due to lower power consumption and lower cost. Furthermore, it is often that the drivers need to know the elevation and direction of the environment, while currently, no device can provide such functions at the same time, thus the present invention serves to resolve a problem.

### SUMMARY OF THE INVENTION

Accordingly, the object of the present invention is to provide a flash light for a bicycle with the function of direction and elevation indication which has light sources of LEDs.

To achieve above object, the present invention provides a flash light for a bicycle with the function of direction and elevation indication, wherein a flash light for a bicycle with the function of direction and elevation indication, comprising: a casing; the casing having a through hole; a front end of an interior of the casing having a lamp seat; a ball shape compass having a magnetic direction indicator and scales at an upper surface thereof for indication of direction; an upper side of the compass exposing out of the casing from the through hole of the casing, while other portion of the compass being hidden within the casing; a circuit board installed within the casing; the circuit board includes a pressure sensing IC and a processor; the pressure sensing IC serving for sensing the atmosphere and converting the atmosphere into elevation of the place locating the flash light; the pressure sensing IC can transfer signals about the elevations of the flash light to outer side; the processor being connected to the pressure sensing IC for receiving the signals from the pressure sensing IC and processing all signals in the flash light; a display exposing out of a surface of the casing and being connected processor for displaying values about the elevation from the pressure sensing IC; a touch switch installed within the casing and being in contact with a lower side of the ball shape compass; when the compass 20 is pressed, it will press the touch switch so as to actuate a power of the circuit board and thus the elements on the circuit board being actuated; and an LED lamp set installed on the lamp seat at the front end of the casing; the LED lamp set including at least one LED.

The various objects and advantages of the present invention will be more readily understood from the following detailed description when read in conjunction with the appended drawing.

### BRIEF DESCRIPTION OF THE DRAWINGS

FIG. 1 is an exploded view about the flash light for a bicycle with the function of direction and elevation indication of the present invention.

FIG. 2 is an assembled view about the flash light for a bicycle with the function of direction and elevation indication of the present invention.

FIG. 3 is a schematic view about the flash light for a bicycle with the function of direction and elevation indication of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

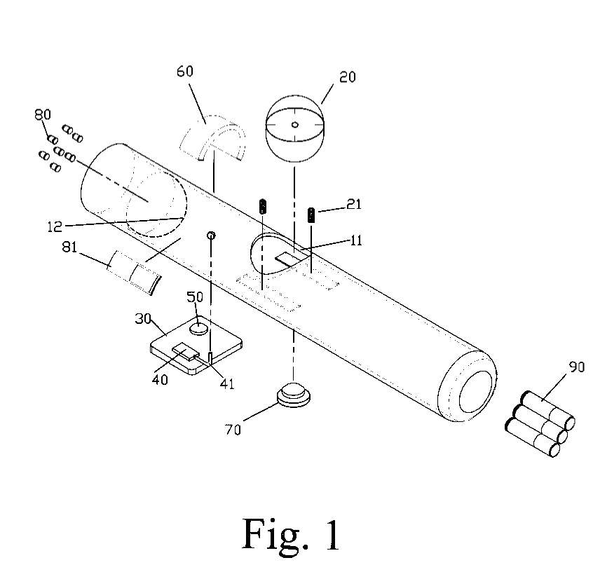

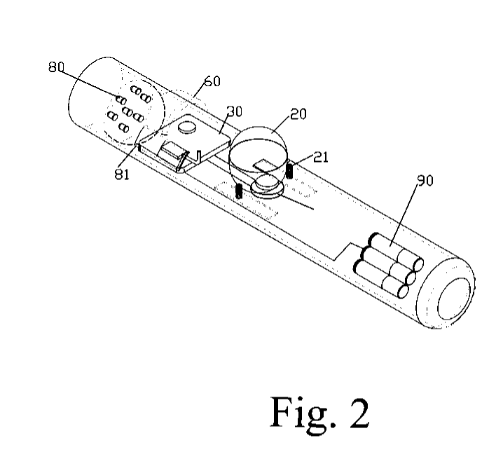

The present invention is related to a flash light for a bicycle with the function of direction and elevation indication. The structure of the present invention will be described herein with reference to FIGS. 1 and 2.

A casing 10 serves for receiving other elements. The casing 10 has a through hole 11. A front end of an interior of the casing 10 has a lamp seat 12 for receiving light source of the flash light.

A ball shape compass 20 has a magnetic direction indicator and scales at an upper surface thereof for indication of direction. An upper side of the compass 20 exposes out of the casing 10 from the through hole 11 of the casing 10, while other portion of the compass 20 is hidden within the casing 10. A lower side of the compass 20 resists with at least one spring 21 (in the drawing two springs 21 are shown, while this is not used to confine the scope of the present invention). The springs provide resilient force as the ball shape compass 20 is pressed so that the compass 20 can restore to the original state.

A circuit board 30 is installed within the casing 10. The circuit board 30 includes a pressure sensing IC (integrated circuit) 40 for sensing the atmosphere and converting the atmosphere into elevation of the place locating the flash light. The pressure sensing IC 40 can transfer signals about the elevations of the flash light to outer side. Preferably, the output signals from the pressure sensing IC 40 are digital signals so that no analog to digital converter is used. An air channel 41 has one end connected to the pressure sensing IC 40 and another end communicating to outer side of the casing for guiding outer air to the sensing point of the pressure sensing IC 40. A processor 50 is connected to the pressure sensing IC 40 for receiving the signals from the pressure sensing IC 40 and processing all signals in the flash light.

A battery set 90 serves to provide power to the flash light.

A display 60 exposes out of a surface of the casing 10 and is connected processor 50 for displaying values about the elevation from the pressure sensing IC 40. The display 60 may be any kind of displays, such as LEDs, LCDs, OLEDs, etc.

A touch switch 70 is installed within the casing 10 and is in contact with a lower side of the ball shape compass 20. When the compass 20 is pressed, it will press the touch switch 70 so as to actuate a power of the circuit board 30 and thus the elements on the circuit board 30 is actuated.

An LED lamp set 80 is installed on the lamp seat 12 at the front end of the casing 10. The LED lamp set 80 includes at least one LED which is powered from the battery set 90.

An LED lamp set switch 81 serves for actuating the LED lamp set 80. When the LED lamp set switch 81 is turned on, and if the touch switch 70 also actuates the circuit board 30, the LED lamp set 80 will light up. On the contrary, when the LED lamp set switch 81 is turned off, the LED lamp set 80 will not light up. That is, the LED lamp set 80 is not controlled by the touch switch 70. By the installation of the LED lamp set switch 81, in daytime, the user can turn on the touch switch 70 to display the elevation which the LED lamp set 80 does not light up so as to save more power.

In the present invention, the LED lamp set switch 81 can combine with a variator (variable resistor) which is installed at an input end of the LED lamp set 80 for controlling the illumination of the LED lamp set 80.

In use of the present invention, when the user presses the ball shape compass 20, it will press the touch switch 70, so that the touch switch 70 actuates the power of the circuit board 30. At this moment, the pressure sensing IC 40 will detect the atmosphere from the air channel 41 and convert the detected atmosphere value into signals which is then transferred to the processor 50 for displaying on the display 60. Meantime, when the LED lamp set switch 81 is no, the LED lamp set 80 will light up to illuminate the environment. On the contrary, when the LED lamp set 80 does not light up, the user can still see the direction from the compass 20 and the elevation from the display 60. The main feature of the present invention is that the present invention not only provides the function of illumination, but also has the function of direction and elevation indication.

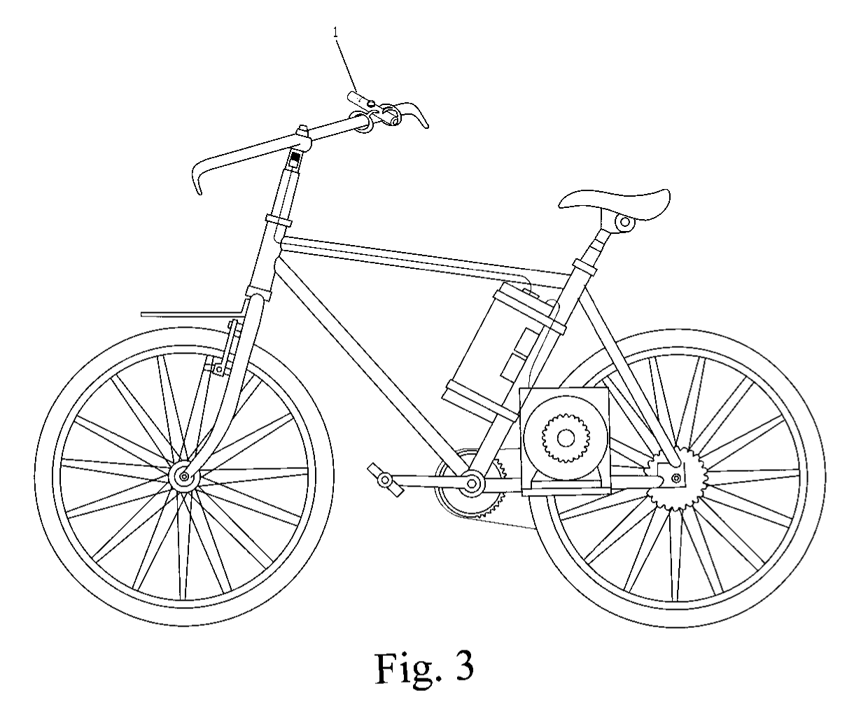

FIG. 3 shows that in use of the present invention, the flash light can be placed on a handle of a bicycle for illumination and the direction and elevation can be viewed.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A flash light for a bicycle with the function of direction and elevation indication, comprising:
a casing; the casing having a through hole; a front end of an interior of the casing having a lamp seat;
a compass having a magnetic direction indicator and scales at an upper surface thereof for indication of direction; an upper side of the compass exposing out of the casing from the through hole of the casing, while other portion of the compass being hidden within the casing;
a circuit board installed within the casing; the circuit board includes a pressure sensing IC and a processor; the pressure sensing IC serving for sensing the atmosphere and converting the atmosphere into elevation of the place locating the flash light; the pressure sensing IC can transfer signals about the elevations of the flash light to outer side; the processor being connected to the pressure sensing IC for receiving the signals from the pressure sensing IC and processing all signals in the flash light;
a display exposing out of a surface of the casing and being connected to the processor for displaying values about the elevation from the pressure sensing IC;
a touch switch installed within the casing and being in contact with a lower side of the compass; when the compass is pressed, it will press the touch switch so as to actuate a power of the circuit board and thus the elements on the circuit board being actuated; and
an LED lamp set installed on the lamp seat at the front end of the casing; the LED lamp set including at least one LED.

2. The flash light for a bicycle with the function of direction and elevation indication as claimed in claim 1, wherein the compass has a ball like shape.

3. The flash light for a bicycle with the function of direction and elevation indication as claimed in claim 1, wherein output signals from the pressure sensing IC are digital signals.

4. The flash light for a bicycle with the function of direction and elevation indication as claimed in claim 1 wherein an air channel has one end connected to the pressure sensing IC and another end communicating to outer side of the casing for guiding outer air to the sensing point of the pressure sensing IC.

5. The flash light for a bicycle with the function of direction and elevation indication as claimed in claim 1, wherein the display 60 is one of LED displays, LCD displays, and OLED displays.

6. The flash light for a bicycle with the function of direction and elevation indication as claimed in claim 1, wherein an LED lamp set switch serves for actuating the LED lamp set; when the LED lamp set switch is turned on, and if the touch switch also actuates the circuit board, the LED lamp set will light up; on the contrary, when the LED lamp set switch is turned off, the LED lamp set will not light up.

7. The flash light for a bicycle with the function of direction and elevation indication as claimed in claim 1, wherein the LED lamp set switch combines with a variator which is installed at an input end of the LED lamp set for controlling the illumination of the LED lamp set.

8. The flash light for a bicycle with the function of direction and elevation indication as claimed in claim 1, wherein a lower side of the compass resists with at least one spring for providing resilient force as the ball shape compass is pressed so that the compass can restore to the original state.

9. The flash light for a bicycle with the function of direction and elevation indication as claimed in claim 1, wherein a battery set serves to provide power to the flash light.
